(19) United States
(12) Patent Application Publication
(10) Pub. No.: US 2024/0360844 A1
(43) Pub. Date: Oct. 31, 2024

(54) MAGNETIC ATTRACTION SPLICING FAN

(71) Applicant: HuiZhou Fly Upwards Electron Co.,Ltd., Guangdong (CN)

(72) Inventors: Yonghong Liao, Guangdong (CN); Xinqiang Zhang, Guangdong (CN)

(73) Assignee: HuiZhou Fly Upwards Electron Co.,Ltd., Guangdong (CN)

(21) Appl. No.: 18/344,777

(22) Filed: Jun. 29, 2023

(30) Foreign Application Priority Data
Apr. 26, 2023 (CN) 202320973537.0

(51) Int. Cl. F04D 29/64; F04D 19/00; F04D 29/52; H01F 7/02

(52) U.S. Cl. CPC F04D 29/646; F04D 19/002; F04D 29/522; H01F 7/02

(57) ABSTRACT

A magnetic attraction splicing fan is disclosed, which includes a fan body, wherein a first attraction member and a mortise are disposed on one side of the fan body, and a second attraction member and a tenon are disposed on the other side of the fan body. According to the magnetic attraction splicing fan of the present disclosure, a first attraction member and a mortise are disposed on one side of the fan body, and a second attraction member and a tenon are disposed on the other side of the fan body. When a plurality of fan bodies are spliced, the tenon of one of adjacent fan bodies is directly inserted into the mortise of the other one of the adjacent fan bodies to realize the splicing between the fan bodies.

### CROSS-REFERENCE TO RELATED APPLICATION

This application claims the priority benefit of China application serial no. 202320973537.0, filed on Apr. 26, 2023. The entirety of the above-mentioned patent application is hereby incorporated by reference herein and made a part of this specification.

### BACKGROUND

### Technical Field

The present disclosure relates to the field of cooling fan, in particular to a magnetic attraction splicing fan.

### Description of Related Art

A large number of integrated circuits are used computer components. It is well known, high temperature is the enemy of integrated circuits, because high temperature can not only lead to unstable system operation and shortened service life, but also may even burn out some components. Therefore, heat sinks will be installed in the computer case to the temperature in the chassis to dissipate heat from the inside of the case to achieve the heat dissipation of the computer.

When the existing computer heat sink is working, it is generally through the cooling fan to blow away the heat generated by the integrated circuits. But sometimes by a single cooling fan, the heat dissipation effect achieved is not ideal. Hence there is a splicing cooling fan on the market, but such splicing cooling fan generally only using magnetic attraction splicing for splicing. However, after the fans are spliced, the splicing firmness is insufficient, and may become loose during operation. Therefore, such splicing cooling fans need to be improved.

### SUMMARY

The purpose of the present disclosure is to provide a magnetic attraction splicing fan that can be firmly spliced.

In order to solve the above technical problems, the technical solutions taken by the present disclosure are as followings.

A magnetic attraction splicing fan, including a fan body, wherein a first attraction member and a mortise are disposed on one side of the fan body, and a second attraction member and a tenon are disposed on the other side of the fan body; when a plurality of fan bodies are spliced, the tenon of one of adjacent fan bodies is inserted into the mortise of the other one of the adjacent fan bodies, and the first attraction member and the second attraction member are magnetically attracted to each other.

In one of the embodiments, the first attraction member and the second attraction member are both magnets.

In one of the embodiments, the first attraction member is a magnet and the second attraction member is a magnetically attractable metal member; or the first attraction member is a magnetically attractable metal member and the second attraction member is a magnet.

In one of the embodiments, a connection plug is disposed on one side of the fan body, and a connection socket is disposed on the other side of the fan body; when a plurality of fan bodies are spliced, the connection plug of one of adjacent fan bodies is inserted into the connection socket of the other one of the adjacent fan bodies.

In one of the embodiments, a positioning slot is disposed on one side of the fan body, and a positioning block is disposed on the other side of the fan body; when a plurality of fan bodies are spliced, the positioning block of one of adjacent fan bodies is inserted into the positioning slot of the other one of the adjacent fan bodies.

In one of the embodiments, the magnetic attraction splicing fan further includes a junction box, and a tenon and a connection socket are also disposed on one side of the junction box;

when the junction box and the fan body are spliced, the tenon of the junction box is inserted into the mortise of the fan body, and the connection socket of the junction box is electrically connected with the connection plug of the fan body.

In one of the embodiments, a positioning block is also disposed on one side of the junction box; when the junction box and the fan body are spliced, the positioning block of the junction box is inserted into the positioning slot of the fan body.

In one of the embodiments, shock pads are disposed at corner positions on a front and a back of the fan body, and each shock pad on the back is covered by a magnetic member.

In one of the embodiments, the first attraction member and the second attraction member each have a T-shaped structure.

In one of the embodiments, the connection plug is a PIN with elasticity.

According to the magnetic attraction splicing fan of the present disclosure, a first attraction member and a mortise are disposed on one side of the fan body, and a second attraction member and a tenon are disposed on the other side of the fan body. When a plurality of fan bodies are spliced, the tenon of one of adjacent fan bodies is directly inserted into the mortise of the other one of the adjacent fan bodies to realize the splicing between the fan bodies. After the tenon being inserted into the mortise, the first attraction member and the second attraction member are magnetically attracted to each other. Finally, the fans are combined by means of mortise and tenon splicing and magnetic attraction splicing, which can effectively improve the firmness of the fan body after splicing.

### BRIEF DESCRIPTION OF THE DRAWINGS

FIG. 1 is a schematic view I of the structure according to the magnetic attraction splicing fan of the present disclosure;

FIG. 2 is a schematic view II of the structure according to the magnetic attraction splicing fan of the present disclosure;

FIG. 3 is a splicing section view according to the magnetic attraction splicing fan of the present disclosure;

FIG. 4 is a spliced state view according to the magnetic attraction splicing fan of the present disclosure;

FIG. 5 is a schematic view of the structure of a junction box according to the magnetic attraction splicing fan of the present disclosure.

FIG. 6 is a schematic view of the structure of the first attraction member and the second attraction member according to the magnetic attraction splicing fan of the present disclosure;

FIG. 7 is a schematic diagram of the structure of the shock pad and the magnetic member according to the magnetic attraction splicing fan of the present disclosure.

### DESCRIPTION OF THE EMBODIMENTS

In order to make the above purpose, features and advantages of the present disclosure more obvious and easier to understand, the specific embodiments of the present disclosure will be described in detail in the following in conjunction with the accompanying drawings. In the following description, many specific details are elaborated in order to fully understand the present disclosure. However, the present disclosure may be implemented in many other ways different from those described herein, and those skilled in the art may make similar improvements without violating the content of the present disclosure, so the present disclosure is not limited by the specific embodiments disclosed below.

It should be noted that when a component is said to be “fixed” to another component, it can be directly on top of another component or other components can exist in between. When a component is considered to be “connected” to another component, it can be directly connected to another component or other components can exist in between at the same time. Conversely, when a component is described as “directly on” another component, there is no intermediate component. The terms “vertical”, “horizontal”, “left”, “right” and similar expressions used herein are for illustrative purposes only.

Unless otherwise defined, all technical and scientific terms used herein have the same meaning as those normally understood by those skilled in the technical art of the present disclosure. The terms used in the specification of the present disclosure herein are only for the purpose of describing specific embodiments, and are not intended to limit the present disclosure. As used herein, the terms “and/or” include any and all combinations of one or more related items listed.

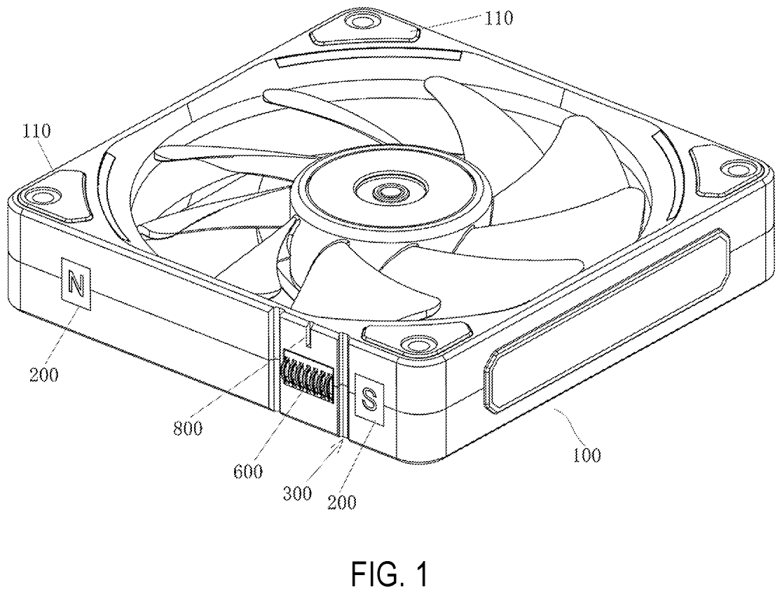

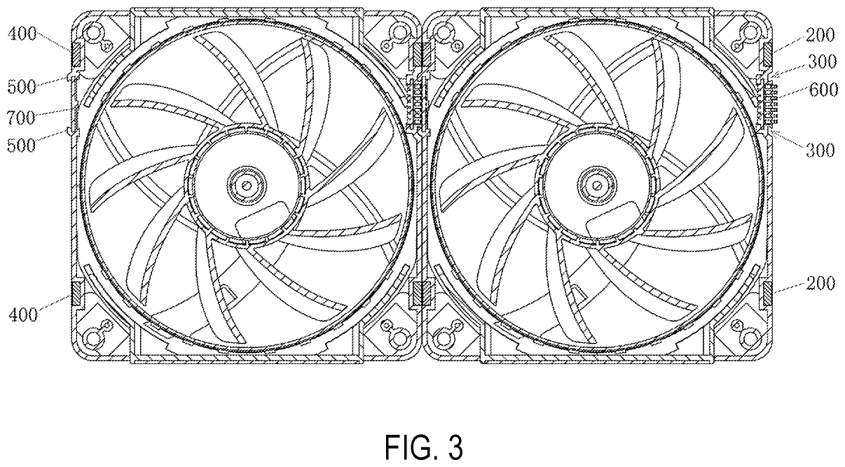

Please refer to FIGS. 1 to 3. A magnetic attraction splicing fan includes a fan body 100, wherein a first attraction member 200 and a mortise 300 are disposed on one side of the fan body 100, and a second attraction member 400 and a tenon 500 are disposed on the other side of the fan body 100. When a plurality of fan bodies 100 are spliced, the tenon 500 of one of adjacent fan bodies 100 is inserted into the mortise 500 of the other one of the adjacent fan bodies 100, and the first attraction member 200 and the second attraction member 400 are magnetically attracted to each other.

Specifically, in the present embodiment, in order to achieve a quick and firm splicing of the fan body 100, two splicing surfaces may be formed on the sides of the fan body 100. A first attraction member 200 and a mortise 300 are provided on one of the splicing surfaces, and a second attraction member 400 and a tenon 500 are provided on the other of the splicing surfaces. When splicing is required, the tenon 500 on the splicing surface of one fan body 100 is inserted into the mortise 300 on the splicing surface of another fan body 100. After the tenon 500 being inserted into the mortise 300, the first attraction member 200 and the second attraction member 400 can be attracted to each other, so that the fans are combined by means of mortise and tenon splicing and magnetic attraction splicing, which can make the splicing between the fan bodies 100 firmer, and make the splicing convenient and simple.

Of course, in order to achieve the magnetic attraction between the first attraction member 200 and the second attraction member 400, in the present embodiment, the first attraction member 200 and the second attraction member 400 are both magnets. Or, the first attraction member 200 is a magnet, and the second attraction member 400 is a magnetically attractable metal member, or the first attraction member 200 is a magnetically attractable metal member, and the second attraction member 400 is a magnet. Magnetic attraction between the first attraction member 200 and the second attraction member 400 can be realized by magnet and magnetically attractable metal member.

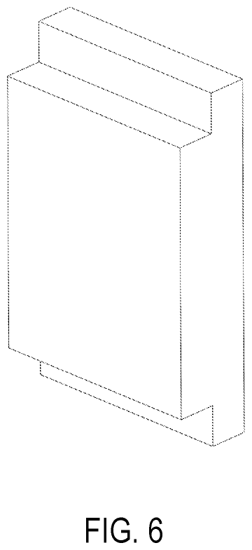

Refer to FIG. 6. In order to facilitate the installation of the first attraction member 200 and the second attraction member 400, the first attraction member 200 and the second attraction member 400 each have a T-shaped structure. By means of the T-shaped structure, the first attraction member 200 and the second attraction member 400 can be easily installed on the splicing surface of the fan body 100.

Furthermore, in the present embodiment, the fan body 100 is square, which has two splicing surfaces, and the two splicing surfaces are opposite surfaces. When the fan body 100 is spliced, because the splicing surfaces are opposite to each other, the spliced fan bodies 100 are spliced side-by-side. And in order to achieve multi-directional splicing, other sides of the fan body 100 can also be formed with splicing surfaces, so that the multi-directional splicing of the fan bodies 100 can be realized.

Referring to FIGS. 1 to 3, in order to achieve wireless splicing of a plurality of fan bodies 100, and easy arrangement of the spliced fan bodies 100 during installation, one side of the fan body 100 is provided with a connection plug 600, and the other side is provided with a connection socket 700.

After a plurality of fan bodies 100 being spliced by means of the first attraction member 200, the second attraction member 400 and the mortise 300 and the tenon 500, the connection plug 600 of one of the fan bodies 100 is connected with the connection socket 700 of another fan body 100, thereby forming an electrical connection, and forming a wireless splicing, so that it is convenient to install and arrange the plurality of fan bodies 100 after splicing.

The connection plug 600 in the present embodiment is a PIN with elasticity, and the connection between the connection plug 600 and the connection mother 700 may be ensured by the elastic PIN.

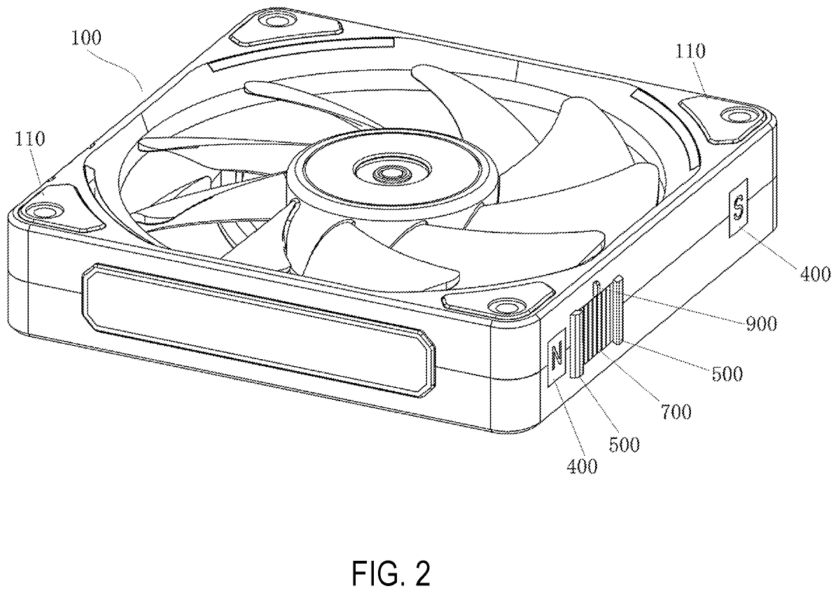

Referring to FIGS. 1 and 2, in order to achieve a quick splicing between the fan bodies 100, one side of the fan body 100 is provided with a positioning slot 800, and the other side is provided with a positioning block 900.

When splicing a plurality of fan bodies 100, the positioning block 900 of one of the fan bodies 100 and the positioning slot 800 of another fan body 100 is positioned, and the positioning block 900 is inserted into the positioning slot 800, so as to realize the positioning between the tenon 500 and the mortise 300, the connecting plug 600 and the connecting socket 700, the first attraction member 200 and the second attraction member 400, and finally, it is convenient for the fan body 100 to be quickly spliced, and it is easier to splice.

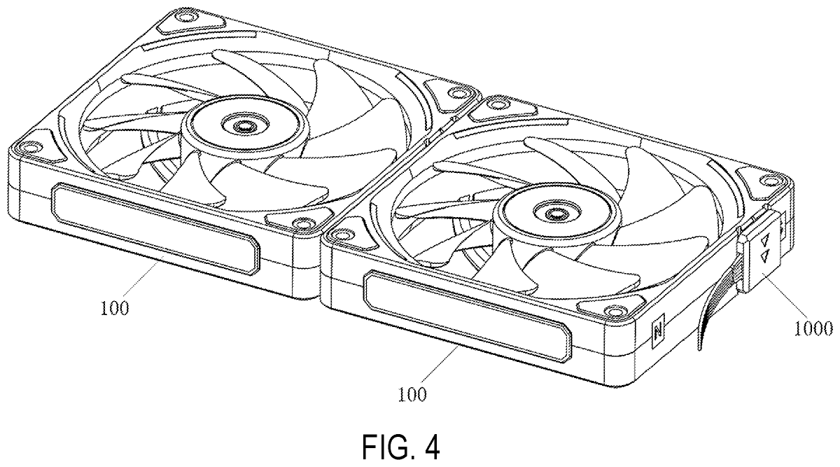

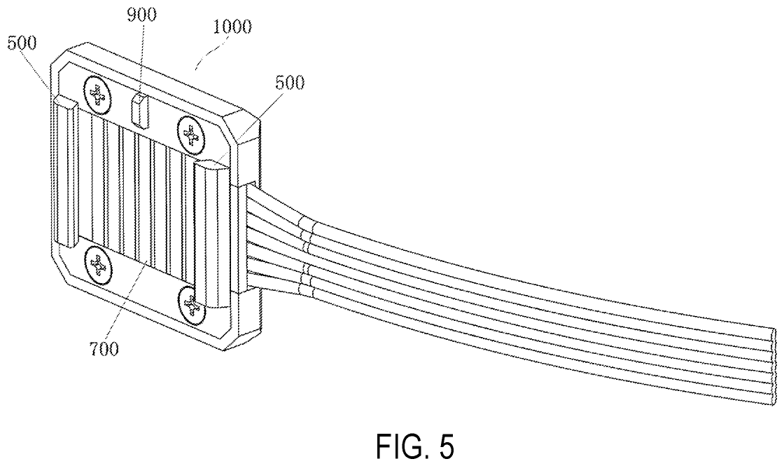

Referring to FIGS. 4 and 5, in the present embodiment, in order to power the spliced fan body 100, a junction box 1000 is further included, and a tenon 500 and a connection socket 700 are also disposed on one side of the junction box 1000.

When the junction box 1000 and the fan body 100 are spliced, similarly, the tenon 500 of the junction box 1000 is inserted into the mortise 300 of the fan body 100, and the connection socket 700 of the junction box 1000 and the connection plug 600 of the fan body 100 are electrically connected, thereby realizing the power supply to the fan body 100.

Of course, in order to facilitate the rapid splicing of the junction box 1000 and the fan body 100, one side of the junction box 1000 is also provided with a positioning block 900. During splicing, the positioning block 900 of the junction box 1000 is inserted into the positioning slot 800 of the fan body 100, which can also facilitate the positioning between the tenon 500 of the junction box 1000, the connection socket 700 and the mortise 300, the connection plug 600, so that facilitates the rapid splicing of the junction box 1000 and the fan body 100.

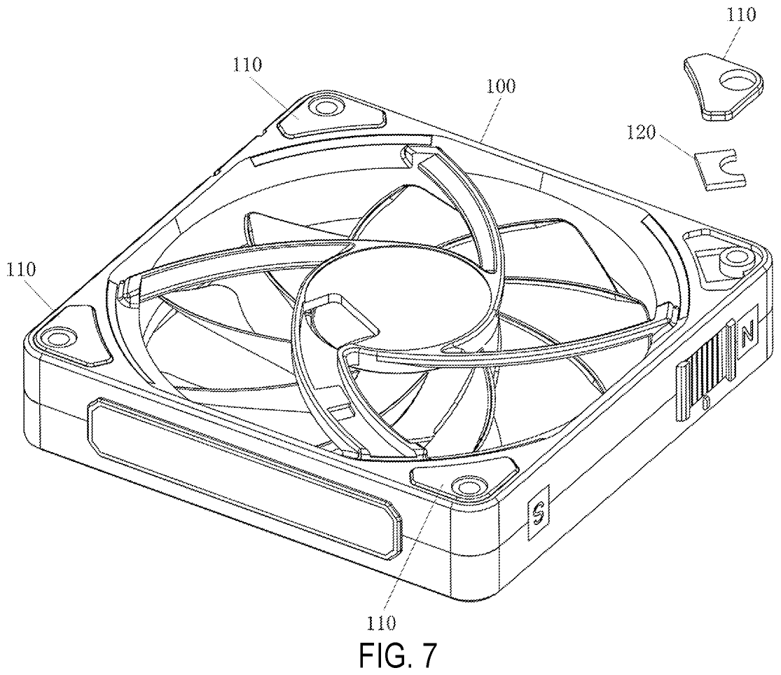

Finally, refers to FIG. 7. Since the fan body 100 will have a slight vibration during operation, in the present embodiment, the front and back four corners of the fan body 100 are provided with shock pads 110. Through the shock pad 110, the noise that occurs when the fan body 100 is running can be effectively reduced. At the same time, each of the back shock pads 110 is also covered with a magnetic member 120, and through the magnetic member 120, it is convenient to install the fan body 100 on the device.

The above shows and describes the basic principles and main features of the present disclosure and the advantages of the present disclosure. All technicians in the art may smoothly implement the utility model as shown in the drawings attached to the specification and as described above. However, all technical personnel familiar with the present specialty, without departing from the scope of the technical solution of the present utility model, using the technical content disclosed above to make some changes, modifications and equivalent changes in evolution, are equivalent embodiments of the present utility model. At the same time, any equivalent changes, modifications and evolution of the above embodiments made according to the substantive technology of the present utility model are still within the scope of protection of the technical solution of the present utility model.

What is claimed is:

1. A magnetic attraction splicing fan, including a fan body, wherein a first attraction member and a mortise are disposed on one side of the fan body, and a second attraction member and a tenon are disposed on the other side of the fan body; when a plurality of fan bodies are spliced, the tenon of one of adjacent fan bodies is inserted into the mortise of the other one of the adjacent fan bodies, and the first attraction member and the second attraction member are magnetically attracted to each other.

2. The magnetic attraction splicing fan according to claim 1, wherein the first attraction member and the second attraction member are both magnets.

3. The magnetic attraction splicing fan according to claim 1, wherein the first attraction member is a magnet and the second attraction member is a magnetically attractable metal member; or the first attraction member is a magnetically attractable metal member and the second attraction member is a magnet.

4. The magnetic attraction splicing fan according to claim 1, wherein a connection plug is disposed on one side of the fan body, and a connection socket is disposed on the other side of the fan body; when a plurality of fan bodies are spliced, the connection plug of one of adjacent fan bodies is inserted into the connection socket of the other one of the adjacent fan bodies.

5. The magnetic attraction splicing fan according to claim 4, wherein the fan further includes a junction box, and a tenon and a connection socket are also disposed on one side of the junction box; when the junction box and the fan body are spliced, the tenon of the junction box is inserted into the mortise of the fan body, and the connection socket of the junction box is electrically connected with the connection plug of the fan body.

6. The magnetic attraction splicing fan according to claim 4, wherein the connection plug is a PIN with elasticity.

7. The magnetic attraction splicing fan according to claim 1, wherein including a fan body, wherein a positioning slot is disposed on one side of the fan body, and a positioning block is disposed on the other side of the fan body; when a plurality of fan bodies are spliced, the positioning block of one of adjacent fan bodies is inserted into the positioning slot of the other one of the adjacent fan bodies.

8. The magnetic attraction splicing fan according to claim 7, wherein a positioning block is also disposed on one side of the junction box; when the junction box and the fan body are spliced, the positioning block of the junction box is inserted into the positioning slot of the fan body.

9. The magnetic attraction splicing fan according to claim 1, wherein shock pads are disposed at corner positions on a front and a back of the fan body, and each shock pad on the back is covered by a magnetic member.

10. The magnetic attraction splicing fan according to claim 1, wherein the first attraction member and the second attraction member each have a T-shaped structure.
